(19) United States
(12) Patent Application Publication
(10) Pub. No.: US 2011/0095034 A1
(43) Pub. Date: Apr. 28, 2011

(54) THIN-WALLED CUP

(76) Inventor: THEODORE P. SKALA, Tampa, FL (US)

(21) Appl. No.: 12/954,711

(22) Filed: Nov. 26, 2010

Related U.S. Application Data
(63) Continuation-in-part of application No. 11/503,686, filed on Aug. 14, 2006, now Pat. No. 7,845,512.
(60) Provisional application No. 60/727,270, filed on Oct. 17, 2005.

(51) Int. Cl. B65D 6/28; B29C 51/00; B29C 59/02

(52) U.S. Cl. 220/604; 264/322; 264/293

(57) ABSTRACT

A thin-walled cup is formed of a single piece of polymeric material having a uniform thickness throughout the extent of the single piece of polymeric material. The cup has an outer chamber which extends around an inner chamber. The outer chamber holds a first liquid and the inner chamber holds a second liquid. The liquid in the inner chamber is mixed with the liquid in the outer chamber during drinking from the cup. The cup is made by a thermoforming process. The thermoforming process may include embossing indicia on the cup.

### RELATED APPLICATIONS

This application is a Continuation-in-Part of U.S. patent application Ser. No. 11/503,686, filed Aug. 14, 2006 by Theodore P. Skala. The benefit of the earlier filing date of the aforementioned U.S. patent application Ser. No. 11/503,686 is hereby claimed. The disclosure in the aforementioned 11/503,686 U.S. patent application is hereby incorporated herein in its entirety by this reference thereto. In addition, the benefit of earlier filed Provisional Application No. 60/727,270, filed on Oct. 17, 2005 by Theodore P. Skala is hereby claimed. The disclosure in the aforementioned Provisional Application is hereby incorporated herein in its entirety by this reference thereto.

### BACKGROUND OF THE INVENTION

The present invention relates to a new and improved drinking cup and the method of making the drinking cup. More specifically, the invention relates to a drinking cup having inner and outer chambers which hold different liquids prior to drinking from the cup and the method of forming the drinking cup.

It has previously been suggested that a drinking cup or vessel may have an inner cup which receives liquor and an outer receptacle which extends around the inner cup and receives water or other liquids. Upon drinking from the vessel, the liquor in the inner cup is mixed with the water in the outer receptacle. A drinking vessel having such a construction is illustrated in U.S. Pat. No. 1,168,027. Another drinking cup or vessel is illustrated in U.S. Design Pat. No. 400,398.

### SUMMARY OF THE INVENTION

The invention relates to a thin-walled cup which is integrally formed from a single piece of polymeric material having a uniform thickness. The cup includes a circular outer side wall which extends between a circular outer rim portion and an annular bottom wall of the cup. The outer side wall and bottom wall have the same thickness.

The cup also includes a first circular inner side wall which extends from the annular bottom wall to a circular inner rim portion. A second circular inner side wall extends from the circular inner rim portion to a circular inner bottom wall. The first and second circular inner side walls and the circular inner bottom wall have the same thickness as the circular outer side wall.

The circular inner rim portion includes upper and lower side surface areas having coincident centers of curvature. The upper and lower arcuate side surface areas of the inner rim portion are spaced apart by distance which is equal to the thickness of the circular outer side wall.

The second circular inner side wall and the circular inner bottom wall at least partially define an inner chamber which receives a first liquid. The circular outer side wall and the annular bottom wall at least partially define an outer chamber which extends around the inner chamber and receives a second liquid.

The cup is advantageously made by a thermoforming process from a single piece of polymeric material. The single piece of polymeric material is positioned in a thermoform press and plastically formed to form the cup. Thereafter, the cup is removed from the press. Indicia may be embossed on the inner bottom wall of the cup and/or the outer side wall of the cup.

### BRIEF DESCRIPTION OF THE DRAWINGS

The foregoing and other features of the invention will become more apparent upon a consideration of the following description taken in connection with the accompanying drawings wherein:

FIG. 1 is a schematic pictorial illustration of a thin-walled cup constructed in accordance with the present invention;

FIG. 2 is a plan view, taken generally along the line 2-2 of FIG. 1, further illustrating the construction of the cup;

FIG. 3 is a sectional view, taken generally along the line 3-3 of FIG. 2, further illustrating the construction of the cup;

FIG. 4 is an enlarged sectional view, generally similar to FIG. 3, illustrating the uniform thickness of walls of the cup and the relationship between an inner chamber which receives a first liquid and an outer chamber which receives a second liquid;

FIG. 5 is an enlarged fragmentary illustration of the portion of the cup enclosed by a circle designated by the numeral 5 in FIG. 4;

FIG. 6 is a top plan view of a cup having the same construction as the cup of FIGS. 1-5 and having an inner bottom wall with indicia embossed thereon;

FIG. 7 is a fragmentary schematic plan view of a portion of the cup of FIG. 6, on an enlarged scale, and further illustrating the indicia;

FIG. 8 is a schematic plan view, similar to FIG. 7, illustrating alternative indicia which may be embossed on the inner bottom wall of the cup of FIG. 6;

FIG. 9 is a schematic plan view, similar to FIGS. 7 and 8 illustrating alternative indicia which may be embossed on the inner bottom wall of the cup of FIG. 6;

FIG. 10 is a schematic illustration of a cup having the same construction as the cup of FIGS. 1-5 and illustrating the manner in which indicia may be embossed on a side wall of a cup;

FIG. 11 is an enlarged schematic illustration of a portion of a side wall of a cup and illustrating the manner in which indicia may be embossed on the side wall of the cup of FIG. 10;

FIG. 12 is an enlarged schematic plan view, generally similar to FIG. 11, illustrating the manner in which indicia may be embossed on the side wall of the cup of FIG. 10;

FIG. 13 is a schematic plan view, similar to FIGS. 11 and 12, illustrating the manner in which indicia may be embossed on the side wall of the cup of FIG. 10;

FIG. 14 is a schematic illustration, similar to FIG. 10, illustrating the manner in which alternative indicia is embossed on the side wall of a cup having the construction illustrated in FIGS. 1-5;

FIG. 15 is an enlarged schematic plan view, similar to FIGS. 7-9, illustrating the manner in which alternative indicia may be embossed on the inner bottom wall of the cup of FIG. 14;

FIG. 16 is a schematic illustration depicting the manner in which indicia which forms a first image may be embossed on a side wall of a cup having the same construction as the cup of FIGS. 1-5;

FIG. 17 is a schematic illustration depicting the manner in which indicia forming a second image may be embossed on the side wall of a cup having the construction illustrated in FIGS. 1-5;

FIG. 18 is a schematic illustration depicting the manner in which the cups of FIGS. 16 and 17 may be stacked with the indicia on the side walls of the cups in a first spatial relationship; and

FIG. 19 is a schematic illustration depicting the manner in which the cups of FIGS. 16 and 17 may be stacked with the indicia on the side walls of the cup in a second spatial relationship.

### DESCRIPTION OF SPECIFIC PREFERRED EMBODIMENTS OF THE INVENTION

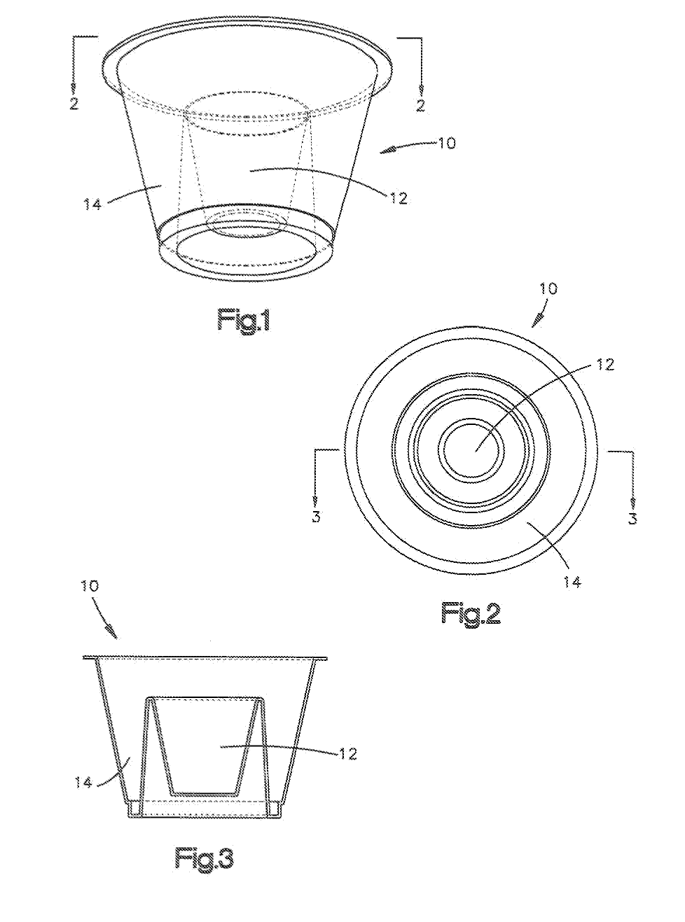

A thin-walled cup 10 (FIG. 1) is integrally formed of a single piece of polymeric material. The single piece of polymeric material has a uniform thickness throughout the extent of the single piece of polymeric material. The thin-walled cup 10 has an inner chamber 12 (FIGS. 1-4) which receives a first liquid, such as an alcoholic liquor. A second or outer chamber 14 extends around the first or inner chamber 12 and receives a second liquid, such as an energy drink. The two liquids are poured into the inner and outer chambers 12 and 14 and are kept separate from each other prior to drinking of the liquids. When an individual drinks from the cup, the liquid in the inner chamber 12 is mixed with the liquid in the outer chamber 14.

Rather than keeping the two liquids separate until an individual drinks from the cup 10, the inner chamber 12 may be filled with the first liquid and then the second liquid may completely fill the second or outer chamber 14. Even though the liquid in the filled outer chamber 14 extends across the inner chamber 12, there is minimal mixing of the two liquids until the cup is tipped during drinking from the cup.

In accordance with one of the features of the invention, the cup 10 is molded by a thermoforming process. During the thermoforming process, a single sheet of polymeric material having a uniform thickness is positioned in a thermoform press. Upper and lower platens in the thermoform press mold at least a portion of the sheet of polymeric material to the configuration of the cup 10. The cup 10 is formed from at least a portion of a single piece of plastic material, such as polystyrene, polyethylene or polypropylene. Of course, polymeric materials other than the aforementioned polymeric materials may be utilized to form the cup 10 if desired

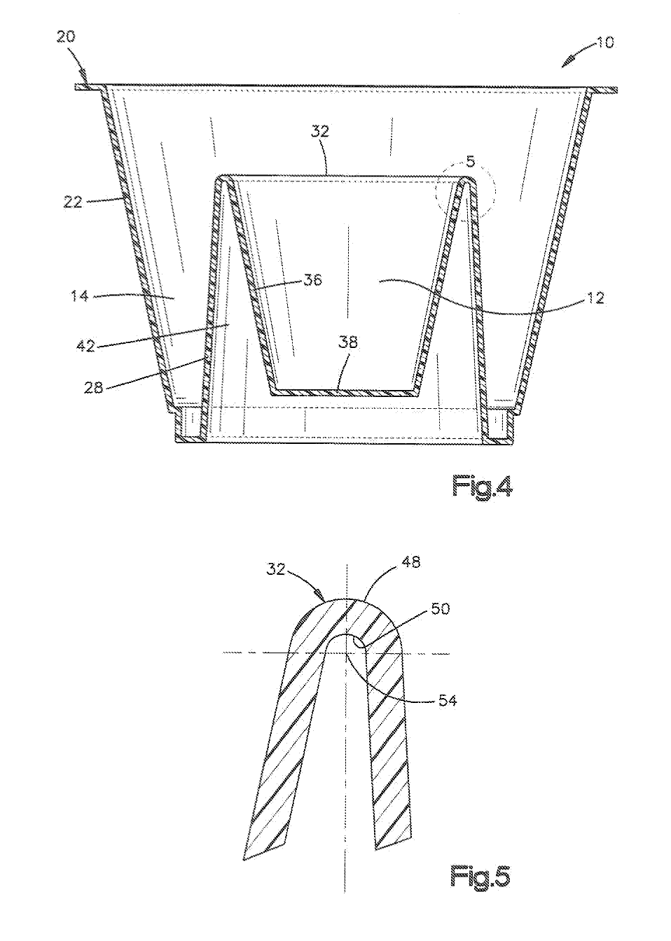

The cup 10 includes a circular outer rim portion 20 (FIG. 4). A circular outer side wall 22 extends downward (as viewed in FIG. 4) from the circular rim 20 to an annular outer bottom wall 24 which is disposed in a coaxial relationship with the outer rim portion 20. The circular outer side wall 22 is formed as a portion of a right circular cone and tapers radially inward and axially downward (as viewed in FIG. 4) from the outer rim portion 20 toward the annular bottom wall 24. If desired, annular undulations may be formed in the outer side wall 22. The annular bottom wall 24 is integrally formed as one piece with the circular outer side wall 22 and has a uniform thickness which is the same as the uniform thickness of the circular outer side wall 22.

A first circular inner side wall 28 extends axially upward (as viewed in FIG. 4) and radially inward from the annular bottom wall 24. The first circular inner side wall 28 and bottom wall 24 are both disposed in a coaxial relationship with the outer rim portion 20. The first circular inner side wall 28 slopes radially inward and axially upward (as viewed in FIG. 4) from the annular bottom wall 24 of the cup 10. The first circular inner side wall 28 has a uniform thickness which is the same as the thickness of the annular bottom wall 24 and circular outer side wall 22.

The first circular inner side wall 28 ends at a circular inner rim portion 32. The circular inner rim portion 32 is disposed between the annular bottom wall 24 and the circular outer rim 20 of the cup 10. The circular inner rim portion 32 is offset downwardly (as viewed in FIG. 4) from the circular outer rim portion 20 and is disposed in a coaxial relationship with the circular outer rim portion 20. The circular inner rim portion 32 extends parallel to the circular outer rim portion 20 of the cup 10. The circular inner rim portion 32 has a uniform thickness throughout the extent of the circular inner rim portion.

A second circular inner side wall 36 slopes radially inward and axially downward from the circular inner rim portion 32 to a circular inner bottom wall 38. The second circular inner side wall 36 is formed as a portion of a right circular cone. The second circular inner side wall 36 has the same slope as the circular outer side wall 22. Therefore, the second circular inner side wall 36 is spaced the same radial distance from the circular outer side wall 22 throughout the extent of the second circular inner side wall. As viewed in a radial cross section plane (FIG. 4), the second circular inner side wall 36 extends parallel to the circular outer side wall 22.

The second circular inner side wall 36 has a uniform thickness throughout its extent. The uniform thickness of the second circular inner side wall 36 is the same as the thickness of the first circular inner side wall 28 and circular outer side wall 22. The second circular inner side wall 36 slopes inwardly away from the first circular inner side wall 28 so that there is a space 42 between the second circular inner side wall 36 and the first circular inner side wall 28 throughout the extent of the second circular inner side wall.

The circular inner bottom wall 38 is disposed in a coaxial relationship with and extends parallel to the annular bottom wall 24. In addition, the circular inner bottom wall 38 is disposed in a coaxial relationship with the circular inner rim portion 32 and circular outer rim portion 20. The circular inner bottom wall 38 extends parallel to the circular inner rim portion 32 and the circular outer rim portion 20.

The circular inner bottom wall 38 is flat and has a uniform thickness throughout its extent. The thickness of the circular inner bottom wall 38 is the same as the thickness of the second circular inner side wall 36 and the annular bottom wall 24.

The circular inner rim portion 32 includes an arcuately curving outer or upper side surface 48 (FIG. 5) and an arcuately curving inner or lower side surface 50. The arcuately curving upper and lower side surfaces 48 and 50 of the circular inner rim portion 32 have coincident centers of curvature, indicated at 54 in FIG. 5. The arcuately curving upper and lower side surfaces 48 and 50 of the circular inner rim portion 32 are spaced apart by the same distance throughout their extent and throughout the extent of the circular inner rim portion 32. The radius of curvature of the arcuately curving upper side surface 48 exceeds the radius of curvature of the lower side surface 50 by an amount which is equal to the thickness of the first circular inner side wall 28 and the thickness of the second circular inner side wall 36.

The uniform thickness of the various walls of the cup 10 and the provision of the space 42 between the inner side walls 28 and 36 of the cup 10 enable a large number of the cups to be compactly stacked. When this is done, the circular rim portion 32 of one cup is positioned adjacent to and in engagement with the circular rim portion 32 of the next lower cup. When the cups are stacked in this manner, the circular inner bottom wall 38 is disposed in abutting engagement with the circular inner bottom wall of the next lower cup. Similarly, the annular bottom wall 24 of an upper cup 10 is disposed in engagement with the annular bottom wall 24 of the next lower cup.

When the cup 10 is to be filled with liquid, the annular bottom wall 24 is positioned on a level support surface, such as a table. A first liquid which may be a liquor, is poured into the inner chamber 12. The inner chamber 12 is filled with the first liquid to a level slightly below the circular rim portion 32. A second liquid, which may be water, beer, or an energy drink, is poured into the outer chamber 14. The outer chamber 14 is filled with the second liquid to a level slightly below the circular rim portion 32. This results in the liquids being kept separate until the cup is tipped to drink the liquids.

The cup 10 may be formed of a transparent, translucent, or opaque material. It may be desired to form the cup 10 so that it is visually clear and does not interfere with viewing of the liquid in the cup.

The thin-walled cup of FIGS. 1-5 is made by thermoforming a single piece of polymeric material having a uniform thickness throughout its extent. To thermoform the single piece of polymeric material to form the cup 10, the single piece of polymeric material is positioned in a thermoform press. A plurality of forming members are utilized in the thermoform press to form the outer side wall 22 (FIG. 4) and outer bottom wall 24 of the cup to at least partially define the outer chamber 14. In addition, the forming members form the inner side wall 36 and inner bottom wall 38 (FIG. 4) of the cup 10 to at least partially define the inner chamber 12. Thereafter, the cup is removed from the thermoform press.

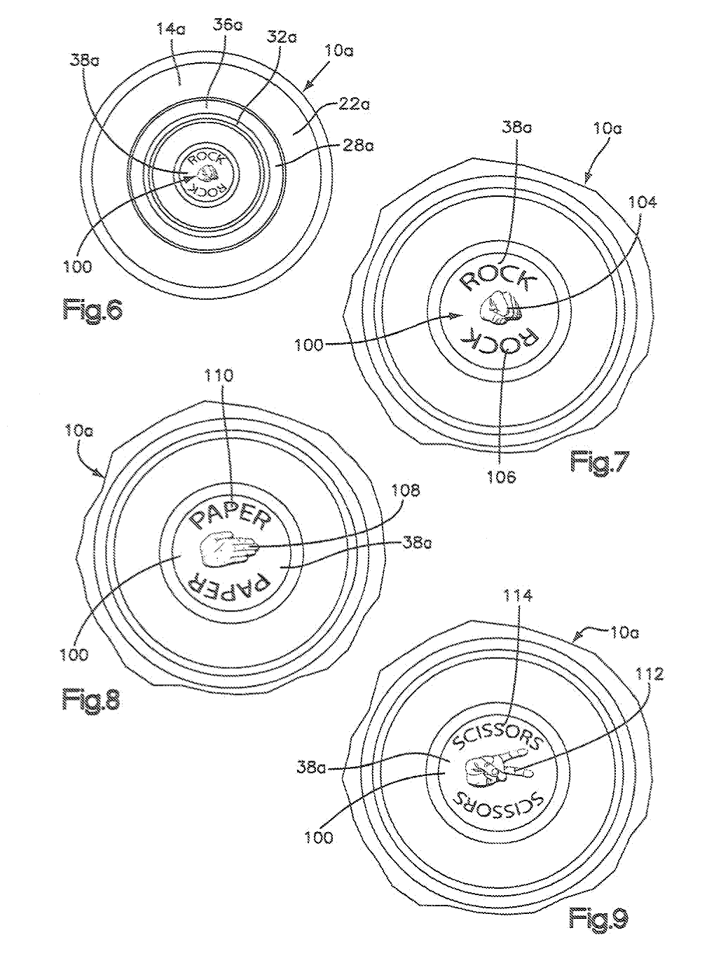

In accordance with another feature of the invention, the forming members in the thermoform press may be constructed to emboss indicia on the outer side wall 22 of the cup 10 and/or on the inner bottom wall 38 of the cup during the formation of the cup. The manner in which indicia is formed on the inner bottom wall of the cup is illustrated schematically in FIGS. 6 through 9. Since the embodiment of the cup illustrated in FIGS. 6-9 is generally similar to the embodiment of the cup illustrated in FIGS. 1-5, similar numerals will be utilize to identify similar components of the cup, the suffix letter “a” being associated with the numerals of FIGS. 6-9 to avoid confusion.

The cup 10a has an outer side wall 22a which cooperates with an outer bottom wall to at least partially define an outer chamber 14a. The first inner side wall 28a extends from the bottom wall to an inner rim potion 32a. A second inner side wall 36a extends from the inner rim portion 32a to an inner bottom wall 38a. It should be understood that the cup 10a may be transparent and has the same general construction as the cup 10 of FIGS. 1-5.

In accordance with a feature of the embodiment of the cup 10a illustrated in FIG. 6, indicia 100 is embossed in the inner bottom wall 38a. The indicia 100 may have any desired form. Thus, the indicia 100 may be made up of alphanumeric symbols or other symbols. Alternatively, the indicia 100 may be formed by images. These images may or may not relate to symbols which are embossed in the inner bottom wall 38a at the same time as the images. Coloring may be applied to the indicia to increase its visibility.

The indicia 100 is embossed in the inner bottom wall 38 during the thermoforming process in which the cup 10a is formed. The forming tools or members used to form the cup 10a in a thermoform press have indicia which corresponds to the indicia 100. These forming members are effective to emboss the indicia 100 in the inner bottom wall 38a of the cup 10a simultaneously with formation of the cup. The cup 10a may be formed of a polymeric material which is transparent, opaque, or translucent.

The indicia 100 on one cup 10a may be different than the indicia 100 on another cup. For example, in the embodiment illustrated in FIG. 7, the indicia 100 includes an image 104 of a fist and symbols 106 spelling “rock”. In the embodiment of the cup 10a illustrated in FIG. 8, the indicia 100 includes an image 108 of an open hand and symbols 110 spelling the word “paper”. In the embodiment of the cup 10a illustrated in FIG. 9, the indicia 100 includes an image 112 of a hand with the index and middle finger extended and spread and symbols 114 spell the word “scissors”.

The illustrated images and symbols 104-114 relate to the well-known game of “rock-paper-scissors”. The indicia 100 is ranked with the image 104 for a rock (which may break scissors) ranked higher than the image 112 for scissors and ranked lower than the image 108 for paper (which may cover a rock). The image 108 for paper ranks lower than the image 112 for scissors (which may cut paper). Therefore, the image 104 of a rock may “defeat” the image 112 of scissors and be “defeated” by the image 108 of paper. The image 108 of paper may “defeat” the image 104 of a rock. The cups 10a of FIGS. 7-9 may be utilized to play the well-known game of rock-paper-scissors.

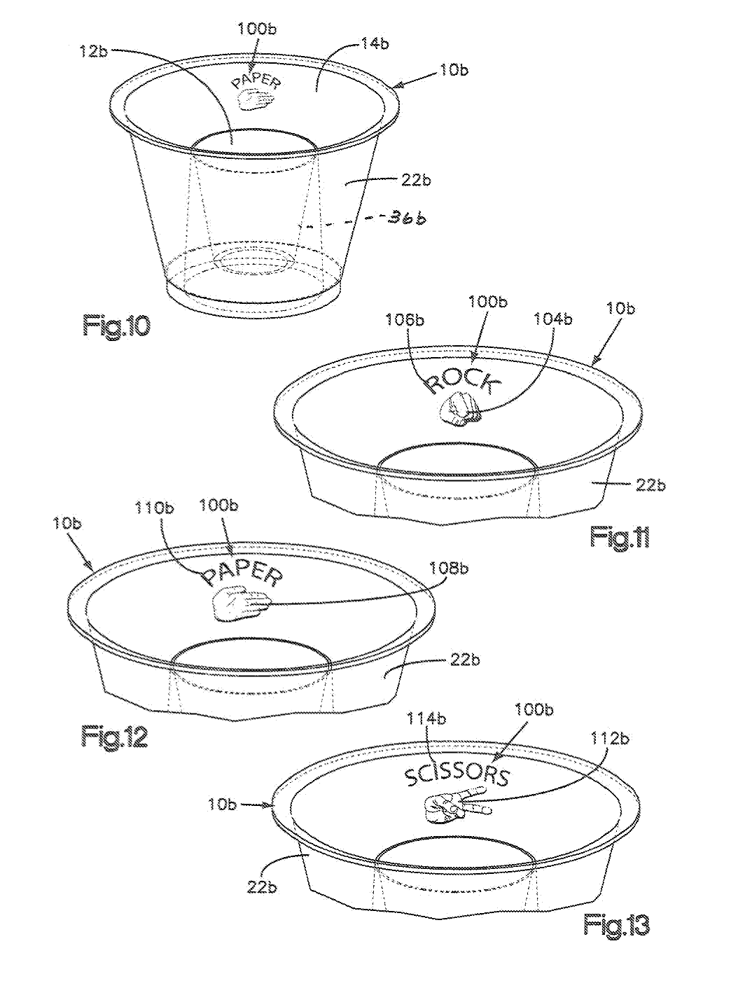

In the embodiment of the invention illustrated in FIGS. 6-9, the indicia 100 is formed in the inner bottom wall 38a of the cup 10a. In the embodiment of FIGS. 10-13, indicia is formed in the side wall of the cup. Since the embodiment of the invention illustrated in FIGS. 10-13 is generally similar to the embodiment of FIGS. 6-9 and includes a cup having the same construction as the cup 10 of FIGS. 1-5, similar numerals will be utilized to designate components of the embodiment illustrated in FIGS. 10-13, the suffix letter “b” being associated with the numerals of FIGS. 10-13 to avoid confusion.

The cup 10b has the same construction as the cup 10 of FIGS. 1-5. The cup 10b includes an outer side wall 22b which cooperates with a bottom wall to at least partially define the outer chamber 14b. The cup includes an inner chamber 12b which is at least partially defined by a second inner side wall 36b.

The indicia 100b is embossed in the outer side wall 22b at the same time which the cup 10b is formed by a thermoforming operation. Members which are utilized to form the outer side wall 22b of the cup have surfaces corresponding to the indicia 100b to enable the members to emboss the indicia 100b in the side wall 22b of the cup 10b during thermoforming of the cup 10b. The cup 10b may be formed of a transparent, translucent, or opaque polymeric material. The indicia 100b may be colored to increase its visibility.

The indicia 100b is illustrated in FIG. 11 and includes an image 104b and symbols 106b. The image 104b and symbols 106b which are formed in the outer side wall 22b of the cup 10b (FIG. 11) are the same as the image 104 and symbols 106 illustrated in FIG. 7.

In the embodiment illustrated in FIG. 12, the indicia 100b is embossed in the outer side wall 22b of the cup 10b. The indicia 100b includes an image 108b and symbols 110b which are the same as the image 108 and symbols 110 of FIG. 8.

The embodiment of the cup 10b illustrated in FIG. 12 includes indicia 100b formed in the outer side wall 22b of the cup. The indicia 100b includes an image 112b and symbols 114b. The image 112b and symbols 114b are embossed in the outer side wall 22b of the cup 10b during thermoforming of the cup 10b.

The indicia 100b has rankings in the same manner as previously explained in conjunction with the indicia 100 of FIGS. 7, 8 and 9. Thus, the indicia 100b of FIG. 11 has a higher ranking the indicia 100b of FIG. 13 and a lower ranking than the indicia 100b of FIG. 12. The indicia illustrated in FIGS. 11-13 may be utilized to play the well-known game of rock-paper-scissors.

It should be understood that the indicia 100a and/or 100b may have the composition which enables it to be utilized to play games other than rock-paper-scissors. Although the indicia 100a and 100b both include images and symbols, the indicia 100a and/or 100b may be formed by only images or only symbols rather than a combination of images and symbols. Although the indicia 100a and 100b is intended for the playing of a well-known game, it is contemplated that the indicia may be utilized for other purposes if desired.

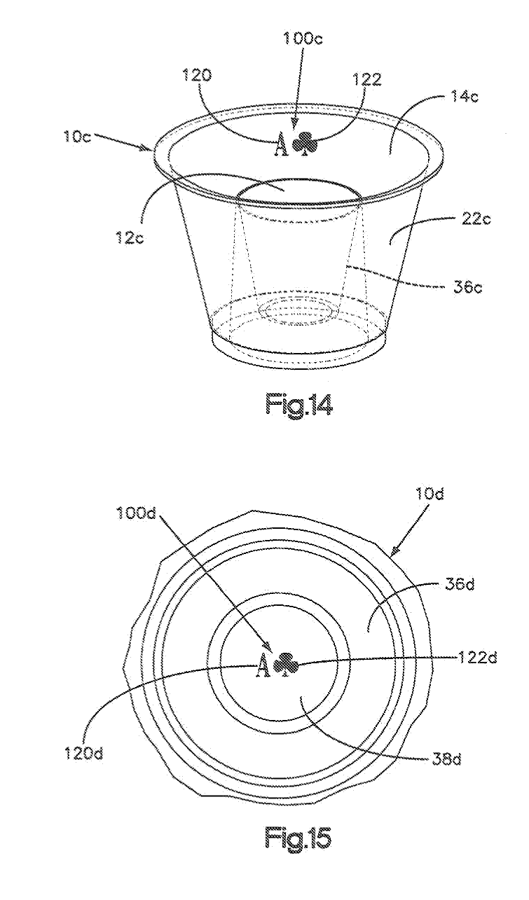

The embodiment of the invention illustrated in FIG. 14 is generally similar to the embodiment of the invention illustrated in FIGS. 1-5 and 10-13. Therefore, similar numerals will be utilized to identify similar components. The suffix letter “c” being associated with the numerals of FIG. 14 to avoid confusion.

A cup 10c (FIG. 14) has the same general construction as the cup 10 of FIGS. 1-5. The cup 10c includes an outer side wall 22c which cooperates with an outer bottom wall 24c to at least partially define an outer chamber 14c. An inner side wall 36c cooperates with an inner bottom wall 38c to at least partially define an inner chamber 12c.

In the embodiment of the invention illustrated in FIG. 14, indicia 100c is embossed in the side wall 22c of the cup 10c during thermoforming of the cup 10c. The indicia 100c is composed of symbols 120 and 122. The symbol 120 is the capital letter “A”, indicating an ace. The symbol 120 may represent one or more cards of any desired valuation or rank. The symbol 120 may be either a letter or numeral.

The symbol 122 indicates the suit of clubs. Thus, the indicia 100c embossed in the side wall 22c represents the ace of clubs. There are 52 combinations of symbols 120 and 122 which may be utilized to represent different cards in a deck of cards. Thus, there are four different symbols 122 for the various suits in a deck of cards and 13 different symbols 120 for various rankings of the cards.

In the embodiment of FIG. 14, indicia 100c is embossed in the side wall 22c of the cup 10c. In the embodiment of FIG. 15, the indicia is embossed in the inner bottom wall of the cup in the same manner as previously described in conjunction with the embodiment of FIGS. 6-9. The cup of FIG. 15 has the same general construction as the cup of FIGS. 1-5. Therefore, similar numerals will be utilized to identify similar components, the suffix letter “d” being associated with the numerals of FIG. 15 to avoid confusion.

A cup 10d has an inner side wall 36d which cooperates with a bottom wall 38d to at least partially form an inner chamber 12d of the cup 10d. In the embodiment illustrated in FIG. 15, indicia 100d is embossed in the inner bottom wall 38d of the cup 10d. The indicia 100d includes symbols 120d and 122d.

The symbol 120d represents a card of a deck of cards, specifically, an ace. It is contemplated that symbol 120d could represent cards of a value or rank other than the ace and that it could be any one of the 13 valuations or rank usually associated with cards in a deck of cards. The symbol 122d represents a suit associated with the ace, specifically, a club. It is contemplated that the symbol 122d may be any one of four different symbols. Through a combination of the symbols 120d and 122d all fifty-two cards normally found in a deck of cards may be represented by the indicia 100d.

The cups 10c and 10d may be formed of a transparent, translucent or opaque polymeric material. The indicia may be colored to increase its visibility. For example, the symbols 120 and 120d may be colored black. The symbols 122 and 122d may be colored black or red depending upon the suits represented by the symbols 122 and 122d.

The indicia 100c of FIG. 14 and the indicia 100d of FIG. 15 each represent only a single card, specifically, the ace of clubs, of a deck of cards. The indicia 100c and/or 100d may have symbols 120 or 120d representing a plurality of cards, for example, the ace, king, queen, jack, and/or the numerals 2 through 10. Similarly, the indicia 100c and/or 100d may be associated with suits other than clubs. For example, the symbols 122 or 122d may represent a heart, diamond or spade. The indicia 100c or 100d may be such as to represent an entire hand of cards, for example, five cards commonly used to play poker. Alternatively, the indicia 100c or may represent thirteen cards commonly used for a hand of bridge.

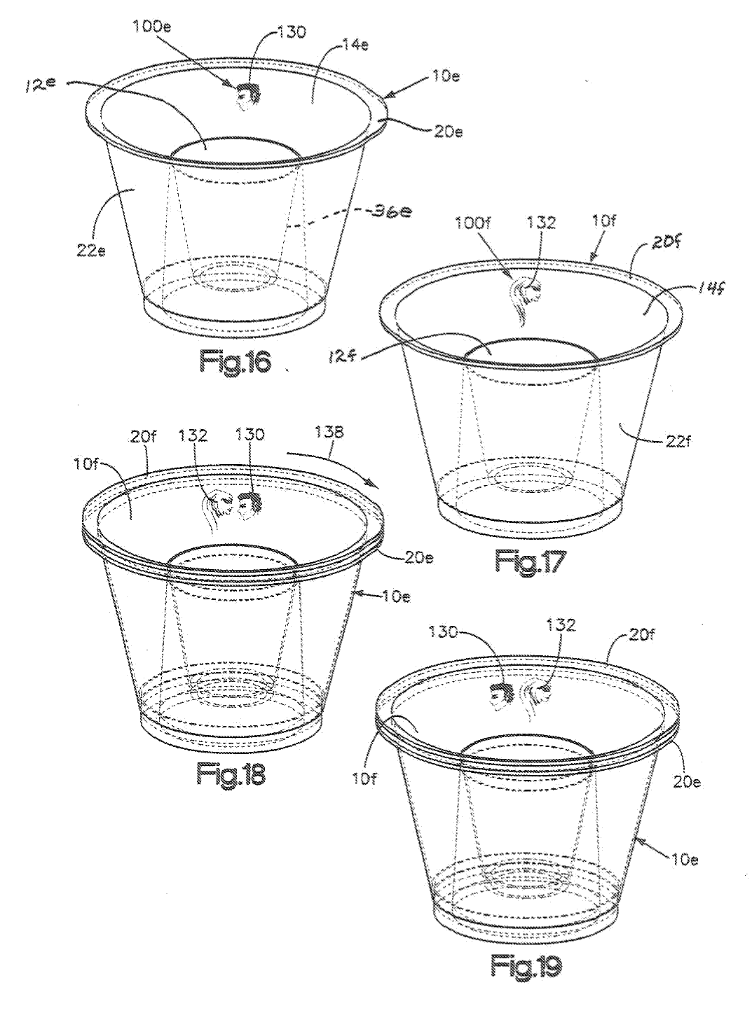

In the embodiment of FIGS. 14 and 15, symbols 120, 122, 120d and 122d are embossed in the cups 10c and 10d. In the embodiment of FIGS. 16, 17, 18 and 19, images are embossed in the cup. Since the embodiment of the invention illustrated in FIGS. 16-19 is generally similar to the embodiments of the invention illustrated in FIGS. 1-15, similar numerals will be utilized to identify similar components, the suffix letter “e” being associated with the cup of FIG. 16 and the suffix letter “f” being associated with the cup of FIG. 17 to avoid confusion.

The cup 10e includes an outer side wall 22e which cooperates with an outer bottom wall to at least partially define an outer chamber 14e. An inner side wall 36e cooperates with an inner bottom wall to at least partially define an inner chamber 12e. It should be understood that the cup 10e of FIG. 16 has the same construction as previously described in connection with the cup of FIGS. 1-5.

In accordance with a feature of the cup 10e of FIG. 16, indicia 100e in the form of an image 130 (FIG. 16) is embossed in the outer side wall 22e of the cup 10e. The image 130 is embossed in the side wall 22e by forming members during thermoforming of the cup 10e from a single piece of polymeric material having a uniform thickness throughout its extent. Thus, as the cup 10e is formed from the single sheet of polymeric material in a thermoforming press, the image 130 is embossed in the outer side wall 22e. Although the illustrated image 130 is a side view of the head of a male person, it should be understood that the image 130 may have any desired configuration and may be of a person, thing, or animal.

A cup 10f is illustrated in FIG. 17. The cup 10f includes an outer side wall 22f which cooperates with an outer bottom wall to at least partially define an outer chamber 14f. An inner side wall 36f cooperates with an inner bottom wall 38f to at least partially define an inner chamber 12f. The cup 10f has the same construction as previously described herein in connection with the cup of FIGS. 1 through 5.

In accordance with a feature of the cup 10f of FIG. 17, indicia 100f in the form of an image 132 is embossed in the outer side wall 22f of the cup 10f. The image 132 is embossed in the outer side wall 22f during the formation of the cup 10f in a thermoforming press in the manner previously described herein. The illustrated image 132 is the head portion of a female person. However, the image 132 may have a different configuration and may correspond to any desired person, thing or animal.

The two cups 10e and 10f may be stacked together to position the images 130 and 132 in a desired spatial relationship relative to each other. The cups 10e and 10f are shown in a stacked relation in FIG. 18 with the image 132 offset to the left (as viewed in FIG. 18) of the image 130. The cups 10e and 10f are advantageously formed of a transparent polymeric material so that the images 130 and 132 can be viewed through the outer side walls 22e and 22f of the cups. The images 130 and 132 may be colored to increase their visibility.

When the cups 10e and 10f are stacked in the order illustrated in FIG. 18, the cup 10e is disposed below the cup 10f. This results in the outer rim portion 20e of the cup 10e being disposed below the outer rim portion 20f of the cup 10f. The cups 10e and 10f are stacked in a coaxial relationship with the cup 10f telescopically received within the cup 10e. Of course, the cup 10f could be disposed below the cup 10e if desired.

The spatial relationship between the images 130 and 132 may be changed by rotating one of the cups, that is, either the cup 10e or the cup 10f, relative to the other cup. For example, if the upper (as viewed in FIG. 18) cup 10f is rotated in the direction of an arrow 138 relative to the cup 10e, the image 132 will move to the position illustrated in FIG. 19 relative to the image 130. While moving relative to each other, the images 130 and 132 may be positioned in any desired spatial relationship relative to each other along an annular path of movement of the images.

The outer rim portions 20e and 20f of the cups 10e and 10f cooperate to maintain the images 130 and 132 in annular paths during relative rotation between the cups 10e and 10f. Although the images 130 and 132 have been shown as being offset for substantially the same distance from the outer rim portions 20e and 20f of the cups 10e and 10f in FIGS. 18 and 19, the images 130 and 132 may be offset by different distances from their associated outer rim portions 20e and 20f.

In the embodiments of the invention illustrated in FIGS. 16-19, the single image 130 has been provided on the cup 10e and the single image 132 has been provided on the cup 10f. If desired a plurality of images may be provided on either or both of the cups 10e and/or 10f. For example, an annular array of spaced apart images may be provided on the cup 10e. A single image may be provided on the cup 10f. When the cups 10e and 10f of the foregoing example are nested, as shown in FIG. 18, the image on the cup 101 may be disposed slightly above the annular array of images on the cup 10e. Rotation of the cup 10f relative to the cup 10e would move the single image on the cup 10f along the annular array of images on the cup 10e. The cup 10f may be sequentially moved in a series of increments relative to the cup 10e so that the single image on the cup 10f appears to move in a step-like-manner along the annular array of images on the cup 10e.

In the embodiments of the cups 10e and 10f illustrated in FIGS. 16 and 17, the indicia 100e and 100f are the images 130 and 132 of the head portions of people. It is contemplated that the indicia 100e and 100f may have a different configuration. For example, instead of the images 130 and 132, symbols may be provided on the cups 10e and/or 10f. For example, an annular array of alphanumeric symbols may be provided on the cup 10e. One or more symbols having any desired configuration may be provided on the cup 10f. By rotating the cup 10f relative to the cup 10e, while the cups are in a stacked relationship, as shown in FIGS. 18 and 19, the symbols on the cup 10f will appear to move along the annular array of symbols on the cup 10e.

It is contemplated that the indicia 100e on the cup 10e and the indicia 100f on the cup 10f may have any desired configuration. For example, the indicia 100e embossed in the cup 10e may be an image of a road or track which extends around the cup 10e. The indicia 100f on the cup 10f may be an image of an automobile. By stacking the cups 10e and 10f in the manner illustrated in FIGS. 18 and 19 and rotating the cup 10f relative to the cup 10e, the automobile, represented by the indicia 100f, would appear to move along the road or track formed by the indicia 100e on the cup 10e.

As another example, the indicia 100e embossed on the cup 10e may be an annular array of symbols representing a game board. The indicia 100f on the cup 10f may represent a game piece. By stacking the cups 10e and 10f in the manner illustrated in FIGS. 18 and 19 and rotating the cup 10f relative to the cup 10e, the game piece, represented by indicia 100f, would appear to move along the annular array of symbols formed by the indicia 100e on the cup 10e.

In the foregoing examples, the indicia 100 has been embossed on either an outer side wall 22 of the cup (FIGS. 10-14 and 16-19) or an inner bottom wall 38 of the cup (FIGS. 6-19 and 15). It is contemplated that the indicia 100 may be embossed on both the outer side wall 22 of the cup and the inner bottom wall 38. The indicia which is embossed on the side wall 12 and bottom wall 38 may be symbols and/or images. If the indicia on one cup 10e or 10f is to be viewed through the side wall 22e or 22f of the other cup, the lower cup or both cups may be transparent. Alternatively, at least one of the cups may be opaque and provided with a transparent window through which indicia on the other cup may be viewed.

In view of the foregoing description, it is apparent that the present invention provides a thin-walled cup 10 which is integrally formed from a single piece of polymeric material having a uniform thickness. The cup includes a circular outer side wall 22 which extends between a circular outer rim portion 20 and an annular bottom wall 24 of the cup. The outer side wall 22 and bottom wall 24 have the same thickness.

The cup also includes a first circular inner side wall 28 which extends from the annular bottom wall 24 to a circular inner rim portion 32. A second circular inner side wall 36 extends from the circular inner rim portion 32 to a circular inner bottom wall 38. The first and second circular inner side walls 28 and 36 and the circular inner bottom wall 38 have the same thickness as the circular outer side wall 22.

The circular inner rim portion 32 includes arcuate upper and lower side surface areas 46 and 50 having coincident centers of curvature. The upper and lower arcuate side surface areas 48 and 50 of the inner rim portion 32 are spaced apart by distance which is equal to the thickness of the circular outer side wall 22.

The second circular inner side wall 36 and the circular inner bottom wall 38 at least partially define an inner chamber 12 which receives a first liquid. The circular outer side wall 22 and the annular bottom wall 24 at least partially define an outer chamber 14 which extends around the inner chamber 12 and receives a second liquid.

The cup 10 is advantageously made by a thermoforming process from a single piece of polymeric material. The single piece of polymeric material is positioned in a thermoform press and plastically formed to form the cup. Thereafter, the cup is removed from the press. Indicia 100 may be embossed on the inner bottom wall of the cup and/or the outer side wall of the cup.

1. A method of making a thin-walled cup having an outer side wall which cooperates with an outer bottom wall to at least partially define an outer chamber and an inner side wall which cooperates with an inner bottom wall to at least partially define an inner chamber which is circumscribed by the outer chamber, said method comprising the steps of providing a piece of polymeric material having a uniform thickness throughout the extent of the piece of polymeric material, thermoforming the piece of polymeric material, said step of thermoforming the piece of polymeric material includes positioning at least a portion of the piece of a polymeric material in a thermoform press, using a plurality of forming members in the thermoform press to form the outer side wall and outer bottom wall of the cup to at least partially define the outer chamber and to form the inner side wall and inner bottom wall of the cup to at least partially define the inner chamber from the piece of polymeric material with the outer chamber circumscribing the inner chamber, and, thereafter, removing the cup from the thermoform press.

2. A method of making a thin-walled cup as set forth in claim 1 wherein said step of using a plurality of forming members in the thermoform press includes embossing indicia on the inner bottom wall of the cup.

3. A method as set forth in claim 1 wherein said step of using a plurality of forming members in the thermoform press includes embossing indicia on the outer side wall of the cup.

4. A method of making a plurality of thin walled cups each of which has an outer side wall which cooperates with an outer bottom wall to at least partially define an outer chamber and an inner side wall which cooperates with an inner bottom wall to at least partially define an inner chamber which is circumscribed by the outer chamber, said method comprising the steps of providing a plurality of pieces of polymeric material having a uniform thickness throughout the extent of each piece of polymeric material, thermoforming each piece of polymeric material, said step of thermoforming each piece of polymeric material includes positioning at least a portion of each piece of polymeric material in a thermoform press, using a plurality of forming members to form the outer side wall and outer bottom wall of each cup of the plurality of cups to at least partially define the outer chambers of each cup of the plurality of cups and to form the inner side wall and inner bottom wall of each cup of the plurality of cups to at least partially define the inner chambers of each cup of the plurality of cups, said step of using a plurality of forming members includes embossing indicia on the inner bottom wall of each cup of the plurality of cups, said step of embossing indicia on the inner bottom wall of each cup of the plurality of cups includes embossing indicia on the inner bottom wall of the first cup having a higher ranking than indicia on the inner bottom wall of a second cup of the plurality of cups and a lower ranking than indicia on the inner bottom wall of a third cup of the plurality of cups and embossing indicia on the inner bottom wall of the third cup having a higher ranking than indicia embossed on the inner bottom wall of the first cup and a lower ranking than indicia on the inner bottom wall of the second cup of the plurality of cups.

5. A plurality of thin-walled cups each of which is formed from a single piece of polymeric material having uniform thickness throughout the extent of said single piece of polymeric material, each of said cups of said plurality of cups comprising an outer side wall which extends between an outer rim portion and an outer bottom wall of said cup, a first inner side wall extending from said outer bottom wall to an inner rim portion, said inner rim portion is disposed in a coaxial relationship with said outer rim portion and is axially offset from said outer rim portion in a direction toward side outer bottom wall, a second inner side wall extending from said inner rim portion to an inner bottom wall, said first inner side wall being spaced apart from said second inner side wall throughout the extent of said first inner side wall, said second inner side wall and said inner bottom wall at least partially defining an inner chamber and said outer side wall and said outer bottom wall at least partially defining an outer chamber which extends around said inner chamber, and indicia which is disposed on said inner bottom wall, said indicia on said inner bottom wall of a first cup of said plurality of cups having a higher ranking than indicia on said inner bottom wall of a second cup of said plurality of cups and a lower ranking than indicia on said inner bottom wall of a third cup of said plurality of cups, said indicia on said bottom wall of said third cup of said plurality of cups having a higher ranking than said indicia on said inner bottom wall of said first cup and a lower ranking than said indicia on said inner bottom wall of said second cup of said plurality of cups.

6. A plurality of thin-walled cups as set forth in claim 5 wherein said indicia on said inner bottom wall of each of said cups of said plurality of cups is embossed in the inner bottom wall of each of said cups during a thermoforming operation.
